(19) United States
(12) Patent Application Publication
(10) Pub. No.: US 2024/0104962 A1
(43) Pub. Date: Mar. 28, 2024

(54) FINGERPRINT FORGERY DETECTION DEVICE AND METHOD OF OPERATING SAME

(71) Applicant: Electronics and Telecommunications Research Institute, Daejeon (KR)

(72) Inventors: Tae Wook KANG, Daejeon (KR); Sung Eun KIM, Daejeon (KR); Kyung Jin BYUN, Daejeon (KR); Kwang IL OH, Daejeon (KR); Jae-Jin LEE, Daejeon (KR)

(73) Assignee: Electronics and Telecommunications Research Institute, Daejeon (KR)

(21) Appl. No.: 18/340,686

(22) Filed: Jun. 23, 2023

(30) Foreign Application Priority Data
Sep. 23, 2022 (KR) 10-2022-0120404

(51) Int. Cl. G06V 40/40; G06V 10/70; G06V 40/13

(52) U.S. Cl. CPC G06V 40/40; G06V 10/70; G06V 40/1306

(57) ABSTRACT

Disclosed are a fingerprint forgery detection device and a method of operating the same. The fingerprint forgery detection device includes a memory that stores a first feature signal including biological channel feature information of a user, a transmitter including at least one transmission electrode for transmitting a pulse signal to the user, a receiver including at least one reception electrode for receiving a biological channel response signal in response to the transmitted pulse signal, and a signal processor for processing the biological channel response signal to detect whether a fingerprint is forged, and at least one processor that controls the memory, the transmitter, and the receiver.

### CROSS-REFERENCE TO RELATED APPLICATIONS

This application claims priority under 35 U.S.C. § 119 to Korean Patent Application No. 10-2022-0120404 filed on Sep. 23, 2022, in the Korean Intellectual Property Office, the disclosures of which are incorporated by reference herein in their entireties.

### BACKGROUND

Embodiments of the present disclosure described herein relate to a fingerprint forgery detection device and a method of operating the same, and more particularly, relate to a fingerprint forgery detection device using finger biometric channel characteristic information from an electrical pulse response signal for a user's touch and a method of operating the same.

Personal authentication methods using media such as identification cards, credit cards, or public certificates are vulnerable to theft of personal information by others. In the field of personal authentication protection, biometric authentication technology using unique biometric channel characteristics of a user have been researched. The biometric authentication technology is a technology for authenticating or recognizing a user's identity based on physiological characteristics or behavioral characteristics. In the case of using the biometric authentication technology, access availability may be authenticated based on an individual's fingerprint, iris, or face.

Fingerprint authentication technology is inexpensive to develop, does not require complexity, and has high convenience. Therefore, fingerprint authentication technology is widely used as a personal authentication scheme. However, security may become serious due to leakage of personal biometric information due to fingerprint forgery.

### SUMMARY

Embodiments of the present disclosure provide a fingerprint forgery detection device that uses finger biological channel characteristic information from an electrical pulse response signal for a user's touch, and a method of operating the same.

According to an embodiment, a fingerprint forgery detection device includes a memory that stores a first feature signal including biological channel feature information of a user, a transmitter including at least one transmission electrode for transmitting a pulse signal to the user, a receiver including at least one reception electrode for receiving a biological channel response signal in response to the transmitted pulse signal, and a signal processor for processing the biological channel response signal to detect whether a fingerprint is forged, and at least one processor that controls the memory, the transmitter, and the receiver. The signal processor generates a first signal by removing noise from the biological channel response signal, generates a second signal by amplifying the first signal, generates a discrete signal by discretizing the second signal, extracts a second feature signal including the biological channel feature information from the discrete signal, and detects whether the fingerprint is forged or altered based on the first feature signal and the second feature signal.

According to an embodiment, a method of operating a fingerprint forgery detection device includes determining, by at least one processor, whether a first feature signal including biological channel feature information of a user is stored in a memory, and determining whether user information is registered based on a determination result, transmitting, by a transmitter, a second pulse signal to the user in response to a case where the user information is registered as the determination result, receiving, by a receiver, a second biological channel response signal in response to the transmitted second pulse signal, generating, by the receiver, a second discrete signal by discretizing the second biological channel response signal, extracting, by the receiver, a second feature signal including the biological channel feature information from the second discrete signal, and detecting, by the receiver, whether a fingerprint is forged or altered based on the first feature signal and the second feature signal.

According to the present disclosure, it is possible to prevent the risk of leakage of personal information due to leakage of fingerprint authentication information.

In addition, according to the present disclosure, it is possible to implement a fingerprint forgery detection device through contact with a fingerprint sensor without a separate process. Therefore, the convenience of fingerprint forgery detection may be improved.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a fingerprint forgery detection device according to an embodiment of the present disclosure.

FIG. 2 is a block diagram illustrating a signal processor according to an embodiment of the present disclosure.

FIGS. 3A and 3B are diagrams illustrating a contact manner of a fingerprint forgery detection device according to an embodiment of the present disclosure.

FIG. 4 is a graph illustrating an example of a feature signal according to an embodiment of the present disclosure.

FIGS. 5A and 5B illustrate an example of a pulse signal according to an embodiment of the present disclosure.

FIGS. 6A to 6C illustrate an example of a result of applying a pulse signal according to an embodiment of the present disclosure.

FIG. 7 is a block diagram illustrating an operation of a fingerprint forgery detection device according to an embodiment of the present disclosure.

FIG. 8 is a flowchart illustrating a method of operating the fingerprint forgery detection device according to an embodiment of the present disclosure.

### DETAILED DESCRIPTION

Hereinafter, embodiments of the present disclosure will be described clearly and in detail so that those skilled in the art can easily carry out embodiments of the present disclosure.

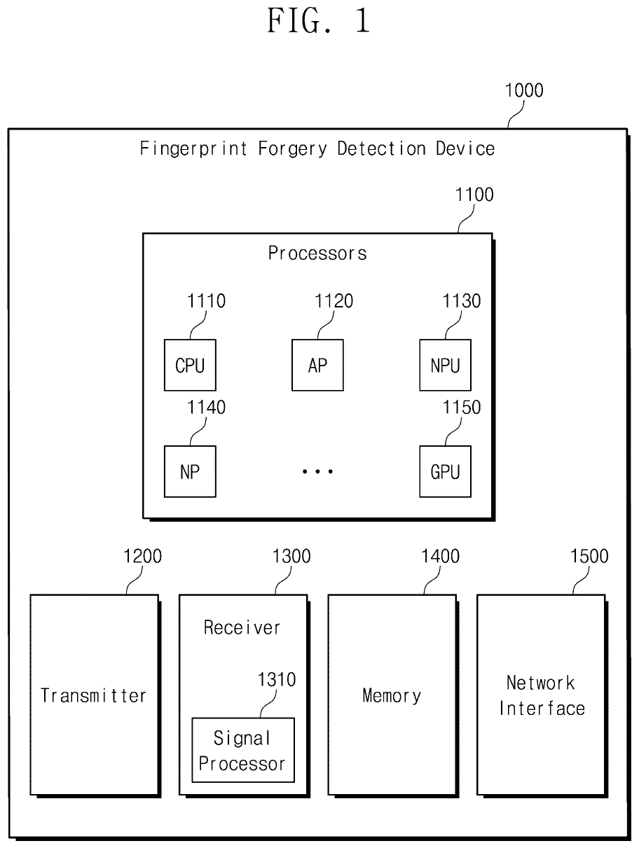

FIG. 1 is a block diagram illustrating a fingerprint forgery detection device 1000 according to an embodiment of the present disclosure. Referring to FIG. 1, the forgery detection device 1000 may include processors 1100, a transmitter 1200, a receiver 1300, a memory 1400, and a network interface 1500.

The processors 1100 may function as a central processing unit of the fingerprint forgery detection device 1000. The processors 1100 may control overall operations of other components included in the fingerprint forgery detection device 1000. The processors 1100 may include at least one general-purpose processor such as a central processing unit (CPU) 1110, an application processor (AP) 1120, or the like. The processors 1100 may also include at least one special purpose processor such as a neural processing unit 1130, a neuromorphic processor 1140, a graphics processing unit (GPU) 1150, or the like. The processors 1100 may include two or more processors of the same type.

At least one (or at least another one) of the processors 1100 may determine whether a first feature signal is stored in a memory, and determine whether user information is registered based on the determination result. In this case, the first feature signal may include biological channel feature information of a user. When user information is not registered in the fingerprint forgery detection device 1000, at least one (or at least another one) of the processors 1100 may control the fingerprint forgery detection device 1000 to register the user information.

At least one (or at least another) of the processors 1100 may be fabricated to implement various machine learning or deep learning modules. For example, at least one (or at least another one) of the processors 1100 may perform machine learning to update the first feature signal stored in a memory based on a second feature signal extracted from a user.

The transmitter 1200 may include a signal source and at least one transmission electrode. The signal source of the transmitter 1200 may output a signal for obtaining at least one feature signal from a user. For example, the signal source of the transmitter 1200 may output at least one pulse signal for obtaining the first feature signal and the second feature signal from a user.

The transmitter 1200 may transmit a signal output through at least one transmission electrode under control of at least one of the processors 1100. For example, the transmitter 1200 may transmit the pulse signal output through at least one transmission electrode to the user's finger when the user's finger contacts at least one transmission electrode. In this case, at least one transmission electrode may be attached to an external fingerprint sensor or arranged within the external fingerprint sensor.

The receiver 1300 may include at least one reception electrode and a signal processor 1310. The receiver 1300 may receive at least one biological channel response signal in response to the transmitted pulse signal under control of at least one of the processors 1100. In this case, the at least one biological channel response signal may be a signal based on the capacitance of a biological channel of a user. For example, the receiver 1300 may receive a biological channel response signal that responds to a pulse signal through at least one reception electrode when a user's finger contacts at least one reception electrode. In this case, at least one reception electrode may be attached to an external fingerprint sensor or arranged within the external fingerprint sensor.

The signal processor 1310 may detect whether the fingerprint is forged or altered by processing the biological channel response signal under control of at least one of the processors 1100. For example, the signal processor 1310 may obtain the first signal by removing noise of the biological channel response signal. The signal processor 1310 may obtain the second signal by amplifying the amplitude of the first signal. The signal processor 1310 may obtain a discrete signal by discretizing the second signal. The signal processor 1310 may extract at least one feature signal including biological channel feature information from the discrete signal. The signal processor 1310 may compare the feature signal stored in the memory with the extracted feature signal to detect whether the fingerprint is forged or altered.

The memory 1400 may store data and process codes processed or scheduled to be processed by the processors 1100. For example, in some embodiments, the memory 1400 may store data to be input to the fingerprint forgery detection device 1000 or data generated or learned in the process of performing machine learning by the processors 1100. The memory 1400 may store at least one piece of feature information extracted from the fingerprint forgery detection device 1000 under control of the processors 1100.

The memory 1400 may be used as a main memory device of the fingerprint forgery detection device 1000. The memory 1400 may include dynamic RAM (DRAM), static RAM (SRAM), phase-change RAM (PRAM), magnetic RAM (MRAM), ferroelectric RAM (FeRAM), resistive RAM (RRAM), and the like.

The network interface 1500 may provide remote communication with an external device. The network interface 1500 may perform wireless or wired communication with an external device. The network interface 1500 may communicate with an external device through at least one of various communication types such as Ethernet, Wi-Fi, LTE, 5G mobile communication, and the like. For example, the network interface 1500 may communicate with an external device of the fingerprint forgery detection device 1000.

The network interface 1500 may receive operation data to be processed by the fingerprint forgery detection device 1000 from an external device. The network interface 1500 may output result data generated by the fingerprint forgery detection device 1000 to an external device.

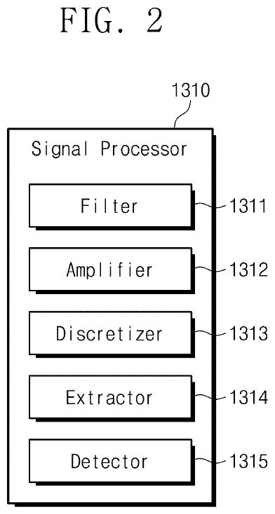

FIG. 2 is a block diagram illustrating the signal processor 1310 according to an embodiment of the present disclosure. Referring to FIG. 2, the signal processor 1310 may include a filter 1311, an amplifier 1312, a discretizer 1313, an extractor 1314, and a detector 1315.

The filter 1311 may remove noise from the received signal under control of at least one of the processors 1100. For example, the filter 1311 may generate the first signal by removing noise from the received biological channel response signal.

The amplifier 1312 may amplify the amplitude of the received signal under control of at least one of the processors 1100. For example, the amplifier 1312 may generate the second signal by amplifying the amplitude of the first signal received from the filter 1311.

The discretizer 1313 may discretize (or sample) the received signal under control of at least one of the processors 1100. For example, the discretizer 1313 may discretize the second signal received from the amplifier 1312 to generate the discrete signal.

In some embodiments, the discretizer 1313 may be an analog-to-digital converter (ADC) that converts the second signal into a digital signal and discretizes the digital signal to generate the discrete signal.

In some embodiments, the discretizer 1313 may be a comparator that discretizes the second signal based on at least one reference voltage. For example, the discretizer 1313 may compare the second signal with a first reference voltage and a second reference voltage, which are different from each other, and discretize the second signal based on the comparison result.

The extractor 1314 may extract at least one feature signal including biological channel feature information from the received signal under control of at least one of the processors 1100. For example, the extractor 1314 may extract at least one feature signal including the biological channel feature information of the user from the discrete signal received from the discretizer 1313. In this case, the memory 1400 may store at least one extracted feature signal under control of the processor.

The detector 1315 may detect whether the fingerprint is forged or altered based on the feature signal stored in the memory and the extracted feature signal under control of at least one of the processors 1100. For example, the detector 1315 may detect whether the fingerprint is forged or altered based on the first feature signal stored in the memory and the extracted second feature signal.

As another example, the detector 1315 may compare the first feature signal stored in the memory and the extracted second feature signal. The detector 1315 may detect whether the second feature signal is forged or altered based on the comparison result.

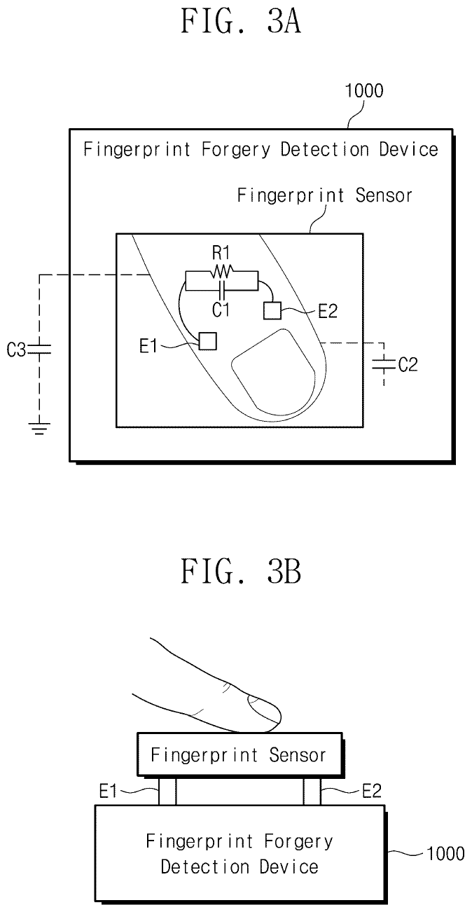

FIGS. 3A and 3B are diagrams illustrating a contact manner of a fingerprint forgery detection device according to an embodiment of the present disclosure. Referring to FIGS. 1, 3A and 3B, the fingerprint forgery detection device 1000 may be attached to an external fingerprint sensor through a transmission electrode E1 of the transmitter 1200 and a reception electrode E2 of the receiver 1300.

A biometric channel of a user may be formed through contact between a user's finger and an external fingerprint sensor. The formed biological channel may be modeled with components of a first resistance R1 and a first capacitance C1. In this case, the first resistance R1 and the first capacitance C1 may be modeled as a parallel connection, and the first resistance R1 and the first capacitance C1 may form a high pass filter having a cutoff frequency.

A second capacitance C2 component, which is a coupling capacitance between the user and the fingerprint forgery detection device 1000, may be modeled from the contact between the user's finger and the external fingerprint sensor. A third capacitance C3 component, which is a coupling capacitance between the user and an external ground, may be modeled. When the second capacitance C2 and the third capacitance C3 are modeled, at least one biological channel response signal received from the user may be determined based on the first to third capacitances C1 to C3.

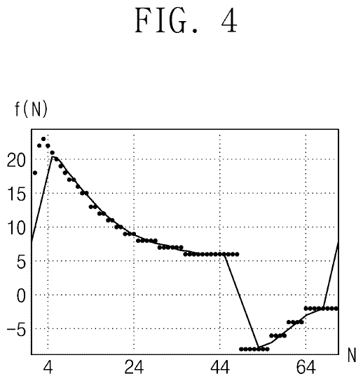

FIG. 4 is a graph illustrating an example of a feature signal according to an embodiment of the present disclosure. In FIG. 4, the horizontal axis represents a length N of the discrete signal (where N is a positive integer), and the vertical axis represents a quantization value. Referring to FIGS. 1, 2 and 4, the extractor 1314 may extract at least one feature signal including the biological channel feature information from the received signal under control of at least one of the processors 1100.

The feature signal extracted from the extractor 1314 may be expressed as a plurality of quantization times and a plurality of quantization values corresponding to the quantization times. For example, the feature signal extracted from the extractor 1314 may be expressed as six quantization times (a, b, c, d, e, g, and h) and six quantization values (f(a), f(b), f(c), f(d), f(e), f(g), and f(h)) corresponding to the six quantization times (a, b, c, d, e, g, and h) (where each of a, b, c, d, e, g, and h is an arbitrary quantization time and is a positive integer). In this case, the six quantization times (a, b, c, d, e, g, and h) may be the result of discretizing the signal input to the discretizer 1313, and the quantization value f( )may be a vector value based on the amplitude value of the discrete signal.

Each of the six quantization values (f(a), f(b), f(c), f(d), f(e), f(g), and f(h)) may correspond to six quantization times (a, b, c, d, e, g, and h). For example, the quantization value f(a) may correspond to the quantization time ‘a’, the quantization value f(b) may correspond to the quantization time ‘b’, the quantization value f(c) may correspond to the quantization time ‘c’, the quantization value f(d) may correspond to the quantization time ‘d’, the quantization value f(e) may correspond to the quantization time ‘e’, the quantization value f(g) may correspond to the quantization time ‘g’, and the quantization value f(h) may correspond to the quantization time ‘h’.

The detector 1315 may detect whether the fingerprint is forged or altered based on the feature signal stored in the memory and the extracted feature signal under control of at least one of the processors 1100.

For example, the detector 1315 may detect whether the fingerprint is forged or altered based on following Equations 1 and 2.

$$\frac{f ( c ) - f ( a )}{c - a} > f ( b ) \qquad [ Equation 1 ]$$

$$f ( e ) < 0 \qquad [ Equation 2 ]$$

Where each of a, b, c, d, e, g, and h is an arbitrary quantization time as a positive integer, ‘N’ represents the length of the discrete signal as a positive integer, a<b<c<d<e<g<h<N, and f( ) is a quantization value corresponding to a quantization time. For example, when N=71, which is the length of the discrete signal, the values of a, b, and c are one of values between 3 and 36, the value of d is 34, and the values of e, g, and h may be one of values between 49 and 70.

When the second feature signal satisfies Equations 1 and 2, the detector 1315 may detect that the fingerprint is not forged or altered.

As another example, the detector 1315 may compare the first feature signal and the second feature signal in a specific section to detect whether the fingerprint is forged or altered. The detector 1315 may detect whether the fingerprint is forged or altered based on following Equation 3.

f(a)≤ . . . ≤f(b)≤ . . . ≤f(c) [Equation 3]

Where each of a, b, and c is an arbitrary quantization time as a positive integer, a<b<c, and f( )is a quantization value corresponding to the quantization time. The detector 1315 may compare results of the first feature signal and the second feature signal for Equation 3 to detect whether the fingerprint is forged or altered. As a comparison result, when result values of the first feature signal and the second feature signal match, the detector 1315 may determine that the fingerprint is not forged or altered. As a comparison result, when result values of the first feature signal and the second feature signal do not match, the detector 1315 may determine that the fingerprint is forged or altered.

As another example, the detector 1315 may compare the first feature signal and the second feature signal in a specific section to detect whether the fingerprint is forged or altered. The detector 1315 may detect whether the fingerprint is forged or altered based on following Equation 4.

f(a)≥ . . . ≥f(b)≥ . . . ≥f(c) [Equation 4]

Where each of a, b, and c is an arbitrary quantization time as a positive integer, a<b<c, and f( )is a quantization value corresponding to the quantization time. The detector 1315 may compare results of the first feature signal and the second feature signal for Equation 4 to detect whether the fingerprint is forged or altered. As a comparison result, when the result values of the first feature signal and the second feature signal match, the detector 1315 may determine that the fingerprint is not forged or altered. As a comparison result, when the result values of the first feature signal and the second feature signal do not match, the detector 1315 may determine that the fingerprint is forged or altered.

As another example, the detector 1315 may compare the first feature signal stored in the memory and the extracted second feature signal. The detector 1315 may detect whether the second feature signal is forged or altered based on the comparison result.

In some embodiments, each of the quantization times and quantization values may be adaptively determined according to the number of discretized signals, the resolution of the discretized signal, the width of the pulse signal, the frequency characteristic of the biological channel response signal, the discretization rate, and the like.

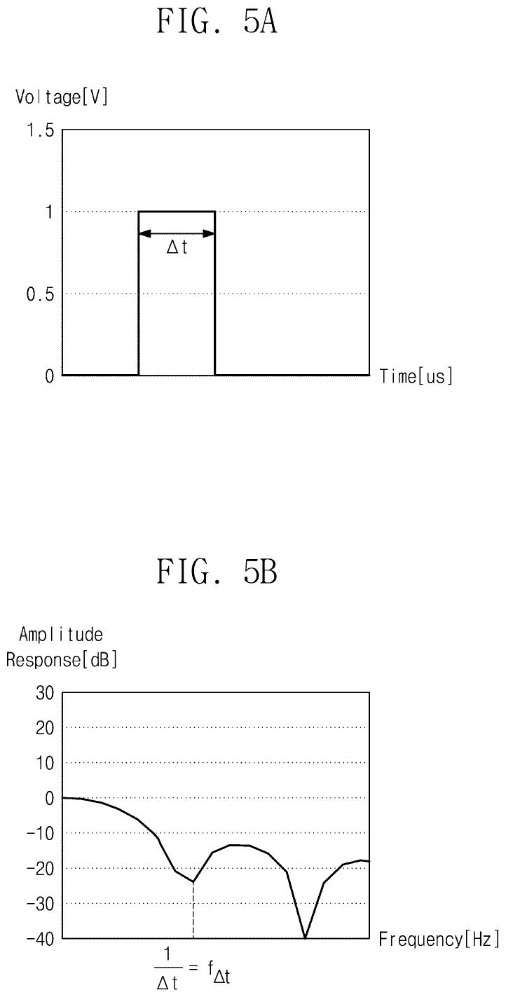

FIGS. 5A and 5B illustrate an example of a pulse signal according to an embodiment of the present disclosure. In FIG. 5A, the vertical axis represents the voltage of the pulse signal, and the horizontal axis represents time. In FIG. 5B, the vertical axis represents the normalized amplitude response of the pulse signal, and the horizontal axis represents the frequency.

Referring to FIGS. 5A and 5B, a pulse signal having a pulse width of a value Δt in the time domain appears as an amplitude response in the form of a sink function in the frequency domain, where the value f_{Δt} the frequency may have the amplitude

$$\frac{1}{Δ t}$$

of as a local minimum value. That is, information on frequency characteristics of pulse response characteristics may be included in a region where the frequency value is less than or equal to f_{Δt}.

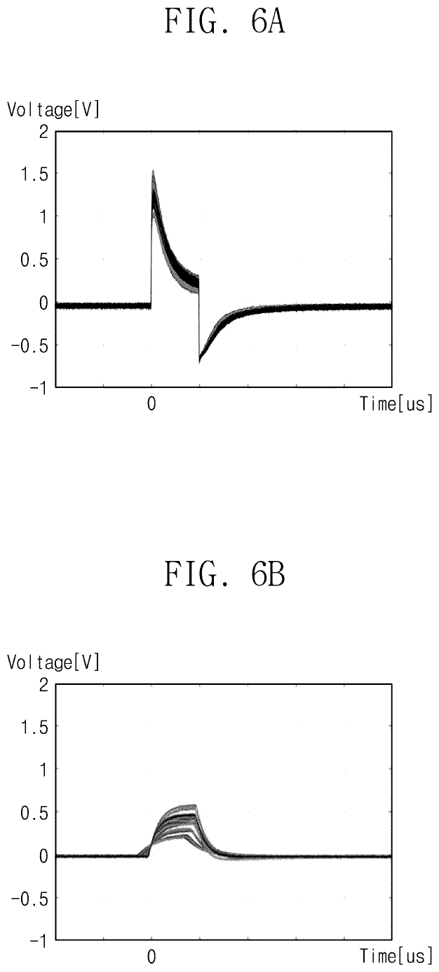

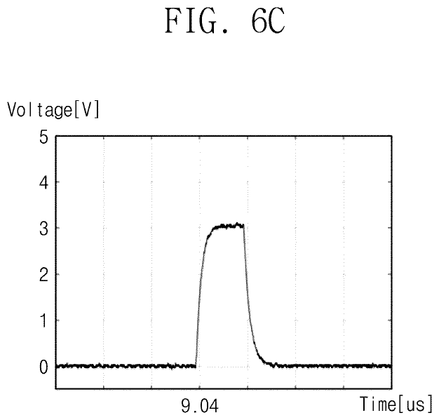

FIGS. 6A to 6C illustrate an example of a result of applying a pulse signal according to an embodiment of the present disclosure. In FIGS. 6A to 6C, the vertical axis represents voltage and the horizontal axis represents time. FIG. 6A illustrates a result of applying a pulse signal to a user's finger, FIG. 6B illustrates a result of applying a pulse signal to a forged fingerprint made of wood glue, and FIG. 6C illustrates a result of applying a pulse signal to a forged fingerprint made of conductive silicon. In this case, the pulse width of the applied pulse signal is 100 us, and the amplitude is 10V.

Referring to FIGS. 4A, 4B and 6A, the resultant value passing through the biological channel is shown in a form in which the amplitude of the voltage increases at the moment when the pulse signal is applied, then decreases to a negative value, and then recovers to 0 (zero) V. That is, the signal passing through the biological channel may appear in the form of passing through a high-pass filter having a specific cut-off frequency. In a signal region where the frequency of the pulse signal changes rapidly, the biological channel response signal may maintain the same level of voltage. In a signal region where the amplitude of the pulse signal does not change, the amplitude of the voltage of the biological channel response signal may decrease. That is, the biological channel of a user may form a high-pass filter due to a resistance component and a capacitance component connected in parallel.

Referring to FIG. 6B, when a plurality of pulse signals are applied, resultant values passing through the forged or altered fingerprint channel appear in the form of a charge/discharge signal of a capacitor. That is, it may be understood that only the resistance component exists in the forged or altered fingerprint channel.

Referring to FIG. 6C, when a plurality of pulse signals are applied, resultant values passing through the forged or altered fingerprint channel appear in the form of a charge/discharge signal of a capacitor. That is, it may be understood that only the resistance component exists in the forged or altered fingerprint channel.

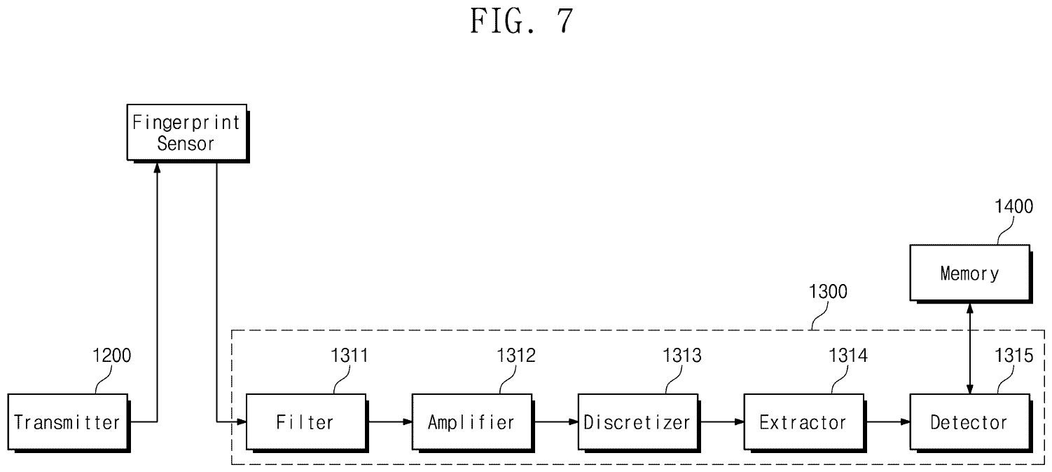

FIG. 7 is a block diagram illustrating an operation of a fingerprint forgery detection device 1000 according to an embodiment of the present disclosure. Referring to FIGS. 1, 2, 4 and 6, the transmitter 1200 may transmit at least one pulse signal under control of at least one of the processors 1100. The receiver 1300 may receive a biological channel response signal in response to the transmitted pulse signal under control of at least one of the processors 1100. The filter 1311 may generate a first signal by removing noise from the biological channel response signal under control of at least one of the processors 1100. The amplifier 1312 may generate a second signal by amplifying the first signal under control of at least one of the processors 1100.

The discretizer 1313 may generate a discrete signal by discretizing the second signal under control of at least one of the processors 1100. In this case, the discretizer 1313 may be an ADC that converts the second signal into a digital signal and discretizes the digital signal to generate the discrete signal, or may be a comparator that discretizes the second signal based on at least one reference voltage.

The extractor 1314 may extract at least one feature signal including biological channel feature information from the discrete signal under control of at least one of the processors 1100. The feature signal extracted from the extractor 1314 may be expressed as a plurality of quantization times and a plurality of quantization values corresponding to the quantization times. For example, the feature signal extracted from extractor 1314 may be expressed as six quantization times (a, b, c, d, e, g, and h) and six quantization values (f(a), f(b), f(c), f(d), f(e), f(g), and f(h)) corresponding to the six quantization times (a, b, c, d, e, g, and h) (where each of a, b, c, d, e, g, and h is an arbitrary quantization time and is a positive integer). Each of the six quantization values (f(a), f(b), f(c), f(d), f(e), f(g), and f(h)) may correspond to the six quantization times (a, b, c, d, e, g, and h).

The detector 1315 may detect whether the fingerprint is forged or altered based on the feature signal stored in the memory 1400 and the extracted feature signal under control of at least one of the processors 1100. For example, the detector 1315 may detect whether the fingerprint is forged or altered based on Equations 1 and 2. When the second feature signal satisfies Equations 1 and 2, the detector 1315 may detect that the fingerprint is not forged or altered.

As another example, the detector 1315 may detect whether the fingerprint is forged or altered based on Equation 3 or Equation 4 described above. The detector 1315 may compare the results of the first feature signal and the second feature signal for Equation 3 or compare the results of the first feature signal and the second feature signal for Equation 4 to detect whether the fingerprint is forged or altered. As a comparison result, when result values of the first feature signal and the second feature signal match, the detector 1315 may determine that the fingerprint is not forged or altered. As a comparison result, when result values of the first feature signal and the second feature signal do not match, the detector 1315 may determine that the fingerprint is forged or altered.

As another example, the detector 1315 may compare the first feature signal stored in the memory and the extracted second feature signal. The detector 1315 may detect whether the second feature signal is forged or altered based on the comparison result.

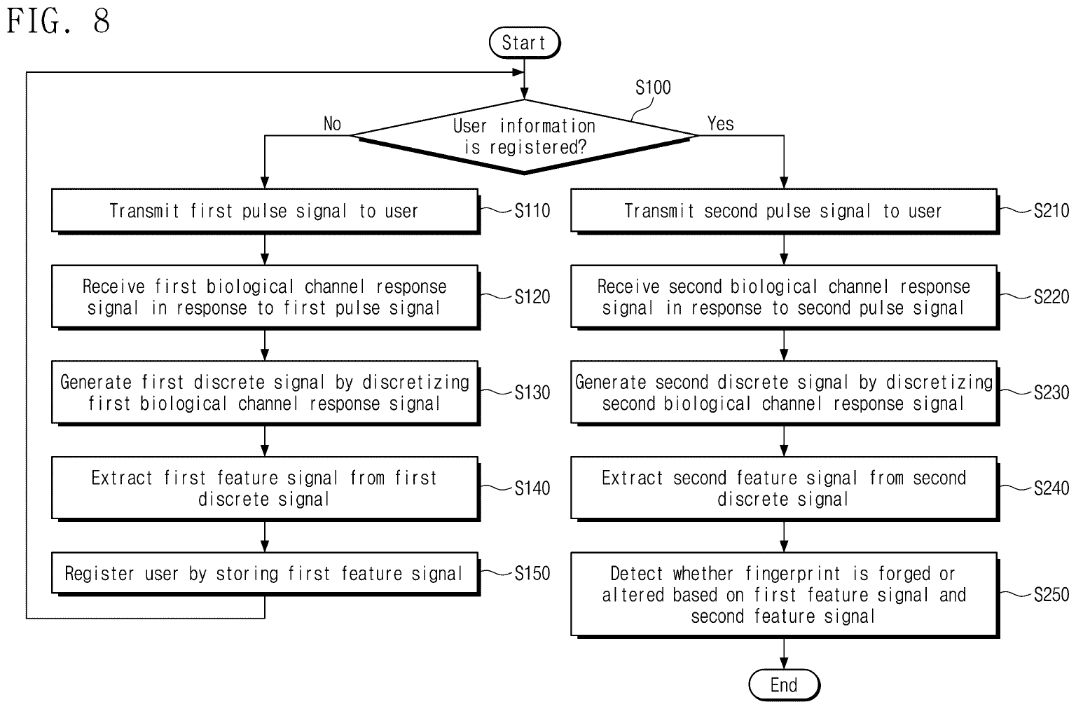

FIG. 8 is a flowchart illustrating a method of operating the fingerprint forgery detection device 1000 according to an embodiment of the present disclosure. Referring to FIGS. 1, 2, 4, 6 and 7, the fingerprint forgery detection device 1000 may perform operations S100 to S150 and S210 to S250.

In operation S100, at least one of the processors 1100 may determine whether user information is registered. For example, at least one of the processors 1100 may check whether the first feature signal including the user's biological channel feature information is stored in the memory, and determine whether the user information is registered based on the check result. As the determination result, in response to the case where the user information is not registered, at least one of the processors 1100 may perform a user information registration process (e.g., operations S110 to S150). In response to the case where the user information is registered as the determination result, at least one of the processors 1100 may perform a forgery detection process (e.g., operations S210 to S250). In this case, operation S100 may be performed when the user's contact on at least one transmission electrode of the transmitter 1200 and at least one reception electrode of the receiver 1300 is identified.

In operation S110, the transmitter 1200 may transmit the first pulse signal to the user under control of at least one of the processors 1100.

In operation S120, the receiver 1300 may receive a first biological channel response signal in response to the transmitted first pulse signal under control of at least one of the processors 1100. In this case, the first biological channel response signal may be a signal that passes through the user's biological channel.

In operation S130, the signal processor 1310 of the receiver 1300 may discretize the first biological channel response signal to generate the first discrete signal. In this case, the first biological channel response signal may be a signal based on the capacitance of the user's biological channel.

For example, the signal processor 1310 may discretize the first biological channel response signal by converting the first biological channel response signal into the digital signal under control of at least one of the processors 1100. The signal processor 1310 may generate the first discrete signal as the discretization result.

As another example, under control of at least one of the processors 1100, the signal processor 1310 may compare the first reference voltage and second reference voltage, which are different from each other, with the first biological channel response signal and discretize the first biological channel response signal. The signal processor 1310 may generate the first discrete signal as the discretization result.

As another example, the signal processor 1310 may remove noise from the first biological channel response signal under control of at least one of the processors 1100. The signal processor 1310 may amplify the amplitude of the noise-removed first biological channel response signal under control of at least one of the processors 1100. The signal processor 1310 may discretize the amplified first biological channel response signal under control of at least one of the processors 1100. The signal processor 1310 may generate the first discrete signal as the discretization result.

In operation S140, the signal processor 1310 may extract the first feature signal from the first discrete signal under control of at least one of the processors 1100. For example, the signal processor 1310 may extract the first feature signal including biological channel feature information of the user from the first discrete signal under control of at least one of the processors 1100.

The first feature signal may be expressed as a plurality of quantization times and a plurality of quantization values corresponding to the quantization times. For example, the first feature signal may be expressed as six quantization times (a, b, c, d, e, g, and h) and six quantization values (f(a), f(b), f(c), f(d), f(e), f(g), and f(h)). Each of the six quantization values (f(a), f(b), f(c), f(d), f(e), f(g), and f(h)) may correspond to the six quantization times (a, b, c, d, e, g, and h).

Each of the quantization times and quantization values of the first feature signal may be adaptively determined according to the number of discretized signals, the resolution of the discretized signal, the width of the pulse signal, the frequency characteristic of the biological channel response signal, the discretization rate, and the like. In addition, the signal processor 1310 may correct each of the quantization times and quantization values of the first feature signal to an average value through several extractions. Each of the quantization time values of the first feature signal may be set to a specific value or determined as a value within a specific range according to circumstances.

In operation S150, at least one of the processors 1100 may register the user information by storing the first feature signal in the memory 1400.

In operation S210, the transmitter 1200 may transmit the second pulse signal to the user under control of at least one of the processors 1100.

In operation S220, the receiver 1300 may receive the second biological channel response signal in response to the transmitted second pulse signal under control of at least one of the processors 1100. In this case, the second biological channel response signal may be a signal that passes through the user's biological channel.

In operation S230, the signal processor 1310 may generate the second discrete signal by discretizing the second biological channel response signal. In this case, the second biological channel response signal may be a signal based on the capacitance of the user's biological channel.

For example, the signal processor 1310 may discretize the second biological channel response signal by converting the second biological channel response signal into the digital signal under control of at least one of the processors 1100. The signal processor 1310 may generate the second discrete signal as the discretization result.

As another example, under control of at least one of the processors 1100, the signal processor 1310 may compare the first reference voltage and the second reference voltage, which are different from each other, with the second biological channel response signal and discretize the second biological channel response signal. The signal processor 1310 may generate the second discrete signal as the discretization result.

As another example, the signal processor 1310 may remove noise from the second biological channel response signal under control of at least one of the processors 1100. The signal processor 1310 may amplify the amplitude of the noise-removed second biological channel response signal under control of at least one of the processors 1100. The signal processor 1310 may discretize the amplified second biological channel response signal under control of at least one of the processors 1100. The signal processor 1310 may generate the second discrete signal as the discretization result.

In operation S240, the signal processor 1310 may extract the second feature signal including the biological channel feature information from the second discrete signal under control of at least one of the processors 1100. For example, the signal processor 1310 may extract the second feature signal from the second discrete signal under control of at least one of the processors 1100.

The second feature signal may be expressed as a plurality of quantization times and a plurality of quantization values corresponding to the quantization times. For example, the second feature signal may expressed as six quantization times (a, b, c, d, e, g, and h) and six quantization values (f(a), f(b), f(c), f(d), f(e), f(g), and f(h)). Each of the six quantization values (f(a), f(b), f(c), f(d), f(e), f(g), and f(h)) may corresponding to the six quantization times (a, b, c, d, e, g, and h).

Each of the quantization times and quantization values of the second feature signal may be adaptively determined according to the number of discretized signals, the resolution of the discretized signal, the width of the pulse signal, the frequency characteristic of the biological channel response signal, the discretization rate, and the like. In addition, the signal processor 1310 may correct each of the quantization times and quantization values of the second feature signal to an average value through several extractions. Each of the quantization time values of the second feature signal may be set to a specific value or determined as a value within a specific range according to circumstances.

In operation S250, the signal processor 1310 may detect whether the fingerprint is forged or altered based on the first feature signal and the second feature signal under control of at least one of the processors 1100.

For example, the detector 1315 may detect whether the fingerprint is forged or altered based on Equations 1 and 2 above. When the second feature signal satisfies Equations 1 and 2, the detector 1315 may detect that the fingerprint is not forged or altered.

As another example, the detector 1315 may detect whether the fingerprint is forged or altered based on Equation 3 or Equation 4 above. The detector 1315 may compare the results of the first feature signal and the second feature signal for Equation 3 or compare the results of the first feature signal and the second feature signal for Equation 4 to detect whether the fingerprint is forged or altered. As a comparison result, when result values of the first feature signal and the second feature signal match, the detector 1315 may determine that the fingerprint is not forged or altered. As a comparison result, when result values of the first feature signal and the second feature signal do not match, the detector 1315 may determine that the fingerprint is forged or altered.

In the above-described embodiments, components according to the technical spirit of the present disclosure have been described using terms such as first, second, and third. However, terms such as “first”, “second”, “third”, and the like are used to distinguish components from each other and do not limit the present disclosure. For example, terms such as “first”, “second”, “third”, and the like do not imply order or numerical meaning in any form.

Specific embodiments have been described above. The present disclosure may include not only the above-described embodiments, but also simple design changes or easily changeable embodiments. In addition, the present disclosure may include techniques that can easily modify and implement the embodiments.

What is claimed is:

1. A fingerprint forgery detection device comprising:
a memory configured to store a first feature signal including biological channel feature information of a user;
a transmitter including at least one transmission electrode for transmitting a pulse signal to the user;
a receiver including at least one reception electrode for receiving a biological channel response signal in response to the transmitted pulse signal, and a signal processor for processing the biological channel response signal to detect whether a fingerprint is forged; and
at least one processor configured to control the memory, the transmitter, and the receiver,
wherein the signal processor is configured to generate a first signal by removing noise from the biological channel response signal, generate a second signal by amplifying the first signal, generate a discrete signal by discretizing the second signal, extract a second feature signal including the biological channel feature information from the discrete signal, and detect whether the fingerprint is forged or altered based on the first feature signal and the second feature signal.

2. The fingerprint forgery detection device of claim 1, wherein the biological channel response signal is based on capacitance of a biological channel of the user.

3. The fingerprint forgery detection device of claim 2, wherein the signal processor includes:
a filter configured to generate the first signal;
an amplifier configured to generate the second signal;
a discretizer configured to generate the discrete signal;
an extractor configured to extract the second feature signal; and
a detector configured to detect whether the fingerprint is forged or altered.

4. The fingerprint forgery detection device of claim 3, wherein the discretizer includes an analog-to-digital converter (ADC), and
the ADC is configured to convert the second signal into a digital signal and discretize the digital signal to generate the discrete signal.

5. The fingerprint forgery detection device of claim 3, wherein the discretizer includes a comparator, and
the comparator is configured to discretize the second signal based on at least one reference voltage.

6. The fingerprint forgery detection device of claim 5, wherein the comparator is configured to compare the second signal with a first reference voltage and a second reference voltage which are different from each other, and discretize the second signal based on a comparison result.

7. The fingerprint forgery detection device of claim 2, wherein the transmission electrode and the reception electrode are attached to an external fingerprint sensor.

8. The fingerprint forgery detection device of claim 2, wherein a value of the second feature signal is expressed as a plurality of quantization times and quantization values corresponding to the quantization times.

9. The fingerprint forgery detection device of claim 8, wherein, based on Equation 1 and Equation 2, whether the fingerprint is forged or altered is detected:
$$\frac{f ( c ) - f ( a )}{c - a} > f ( b ) \qquad [ Equation 1 ]$$
$$f ( e ) < 0 \qquad [ Equation 2 ]$$
wherein a<b<c<e<N, N is a positive integer representing a length of the discrete signal, each of a, b, c, and e is an arbitrary quantization time, and f( )is the quantization value corresponding to the quantization time.

10. The fingerprint forgery detection device of claim 2, wherein a value of the first feature signal and a value of the second feature signal are expressed as quantization times and quantization values corresponding to the quantization times, respectively,
wherein, based on Equation 3, whether the fingerprint is forged or altered is detected:
f(a)≤ . . . ≤f(b)≤ . . . ≤f(c) [Equation 3]
wherein each of a, b, and c is an arbitrary quantization time as a positive integer, f( )) is a quantization value corresponding to the quantization time, and a<b<c.

11. The fingerprint forgery detection device of claim 2, wherein a value of the first feature signal and a value of the second feature signal are expressed as quantization times and quantization values corresponding to the quantization times, respectively,
wherein, based on Equation 4, whether the fingerprint is forged or altered is detected:
f(a)≥ . . . ≥f(b)≥ . . . ≥f(c) [Equation 4]
wherein each of a, b, and c is an arbitrary quantization time as a positive integer, f( )is a quantization value corresponding to the quantization time, and a<b<c.

12. A method of operating a fingerprint forgery detection device, the method comprising:
determining, by at least one processor, whether a first feature signal including biological channel feature information of a user is stored in a memory, and determining whether user information is registered based on a determination result;
transmitting, by a transmitter, a second pulse signal to the user in response to a case where the user information is registered as the determination result;
receiving, by a receiver, a second biological channel response signal in response to the transmitted second pulse signal;
generating, by the receiver, a second discrete signal by discretizing the second biological channel response signal;
extracting, by the receiver, a second feature signal including the biological channel feature information from the second discrete signal; and
detecting, by the receiver, whether a fingerprint is forged or altered based on the first feature signal and the second feature signal.

13. The method of claim 12, further comprising:
registering, by the processor, the user information in response to a case where the user information is not registered as the determination result.

14. The method of claim 13, wherein the registering of the user information includes:
transmitting, by the transmitter, a first pulse signal to the user;
receiving, by the receiver, a first biological channel response signal in response to the transmitted first pulse signal;
generating, by the receiver, a first discrete signal by discretizing the first biological channel response signal;
extracting, by the receiver, the first feature signal from the first discrete signal; and
registering, by the processor, the user information by storing the first feature signal in the memory.

15. The method of claim 14, wherein the generating of the first discrete signal includes generating the first discrete signal by converting the first biological channel response signal into a first digital signal and discretizing the first digital signal, and
wherein the generating of the second discrete signal includes generating the second discrete signal by converting the second biological channel response signal into a second digital signal and discretizing the second digital signal.

16. The method of claim 14, wherein the generating of the first discrete signal includes discretizing the first biological channel response signal based on at least one reference voltage, and
wherein the generating of the second discrete signal includes discretizing the second biological channel response signal based on the reference voltage.

17. The method of claim 16, wherein the discretizing of the first biological channel response signal includes comparing the first biological channel response signal with a first reference voltage and a second reference voltage which are different from each other, and
wherein the discretizing of the second biological channel response signal includes comparing the second biological channel response signal with the first reference voltage and the second reference voltage which are different from each other.

18. The method of claim 14, wherein the generating of the first discrete signal includes:
removing noise from the first biological channel response signal;
amplifying an amplitude of the first biological channel response signal from which the noise is removed; and
discretizing the amplified first biological channel response signal,
wherein the generating of the second discrete signal includes:
removing noise from the second biological channel response signal;
amplifying an amplitude of the second biological channel response signal from which the noise is removed; and
discretizing the amplified second biological channel response signal.

19. The method of claim 14, wherein the first biological channel response signal and the second biological channel response signal are based on a capacitance of a biological channel of the user.

20. The method of claim 19, further comprising:
performing, by the processor, machine learning to update the first feature signal based on the second feature signal in response to that the fingerprint is not forged or altered as a detection result.
